(19) United States
(12) Patent Application Publication
(10) Pub. No.: US 2006/0195511 A1
(43) Pub. Date: Aug. 31, 2006

(54) Configuration of digital content communication systems

(75) Inventors: Donald Dew, Ajax (CA); M. Michael Serbinis, Toronto (CA); Robert Zuber, San Francisco, CA (US)

Correspondence Address: THELEN REID & PRIEST, LLP, P. O. BOX 640640, SAN JOSE, CA, 95164-0640, US

(73) Assignee: Critical Path, Inc., a California Corporation

(21) Appl. No.: 11/353,880

(22) Filed: Feb. 13, 2006

Related U.S. Application Data
(60) Provisional application No. 60/652,261, filed on Feb. 11, 2005.

(51) Int. Cl. G06F 15/16

(52) U.S. Cl. 709/203

(57) ABSTRACT

A method and system for effecting the modification of an operational aspect of a digital content communication system is disclosed. For one embodiment of the invention a request message is received from a user to modify an operational aspect of a digital content communication service. The digital content communication service is identified based upon an origination of the request message. The operational aspect of the digital content communication service is then modified in accordance with the request message. For one embodiment of the invention, the request to modify the operational aspects of a mobile messaging service is sent as a short text message such as an MMS message or an SMS message. For such an embodiment, the request may be sent from a mobile device.

### CROSS-REFERENCE TO RELATED APPLICATION

This application is a non-provisional application claiming priority to provisional application Ser. No. 60/652,261, filed on Feb. 11, 2005, entitled “Message Router and Platform for Routing E-mail Between External E-mail Systems and Simple Hand-held Devices,” which is herein incorporated by reference in its entirety.

### FIELD OF THE INVENTION

Embodiments of the invention relate generally to the field of digital content communication systems and more specifically to the administration and control of mobile digital content communication service using a mobile device.

### BACKGROUND OF THE INVENTION

Typical digital content delivery systems (e.g., mobile messaging systems) allow a user to receive digital content on a mobile communications device (mobile device). The digital content may include e-mail, news feeds (e.g., RSS news), blogs, audio and video clips and multimedia for example, while mobile devices may include hand-held devices such as personal digital assistants (PDAs) and cellular phones or wireless devices having messaging functionality.

Such systems often allow the user to make various changes to the operational aspects of the mobile messaging service. For example, a user may have provided the service provider with a list of certain addresses from which the user desires to receive messages (e.g., e-mail messages) such as a whitelist. A whitelist is a list of e-mail addresses or domain names from which an e-mail filtering program will allow messages to be received. At any given time, a user may wish to change the e-mail addresses on the whitelist.

Additionally, mobile messaging services often allow the user to have digital content that is addressed to one or more destinations forwarded to the mobile device. For example, a user may maintain several external e-mail accounts and have the e-mail messages that get delivered to all of those accounts subsequently delivered to the mobile device. A user may wish to add or delete particular external accounts at various times.

Moreover, a user may desire to suspend or stop service for some reason, and subsequently to resume service.

The aforementioned, and other operational aspects of the mobile messaging account may be modified by the user. Typically, the user must effect such modifications via a fixed-line system such as a web-based or PC client type interface. This may present substantial inconvenience for a user. For example, a user may wish to effect modifications to the operational aspects of their mobile messaging account when access to such fixed-line systems is limited or unavailable (e.g., when traveling).

Some mobile messaging services address this problem through the installation of a client application (an application that relies on a server to perform some operations) on the mobile device. This solution has disadvantages in that it requires the user to download and install the client application on the mobile device. This is often time-consuming and may be beyond the abilities of many users. Moreover, many mobile devices cannot support a client application; it is typically the more sophisticated and more costly mobile devices that are capable of supporting a client application.

Another possible solution to address the problem is through use of a mobile device-based browser. The wireless application protocol (WAP) is a commonly supported specification that allows users to access information via their mobile devices.

WAP supports most wireless networks and most operating systems. WAP clients have been developed that allow internet access from mobile devices. Such WAP clients (often referred to as micro-browsers) have small file sizes that can be accommodated by the limited memory of mobile devices and are specifically devised for small screens. Generally, WAP clients access sites using a specific format (Wireless Markup Language (WML)). However, such protocols and sites are slow and difficult to use.

### SUMMARY OF THE INVENTION

In accordance with one embodiment of the invention a request message is received from a user to modify an operational aspect of a digital content communication service. The digital content communication service and user account is identified based upon an origination of the request message. The operational aspect of the digital content communication service is then modified in accordance with the request message.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 illustrates a system in which the administration and control of a digital content communication system service is effected using a mobile device in accordance with one embodiment of the invention;

FIG. 2 illustrates a process in which changes to the operational aspects of a digital content communication system service are effected in accordance with one embodiment of the present invention; and

FIG. 3 illustrates a functional block diagram of a digital processing system in accordance with one embodiment of the invention.

### DETAILED DESCRIPTION

In accordance with one embodiment of the invention a method for administration and control of mobile digital content communication system services is described. For one embodiment of the invention, a message specifying modification of the operational aspects of a mobile messaging service is received at the operator network of the mobile messaging service. The message is recognized as a request to modify the operational aspects of a mobile messaging service. The message is parsed to determine the modification to the operational aspects of the mobile messaging service, and the requested modifications are effected. For one embodiment of the invention, the request to modify the operational aspects of a mobile messaging service is sent as a short text message from a mobile device.

For various embodiments of the invention, the digital content source affected by the user's requested modification is determined by the request originator (e.g., the user) and the request destination (e.g., the short code). For some embodiments, the content of the message may also be used in determining the affected digital content source (e.g., where the request identifies a particular source).

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable in a variety of settings in which digital content communication systems are configured.

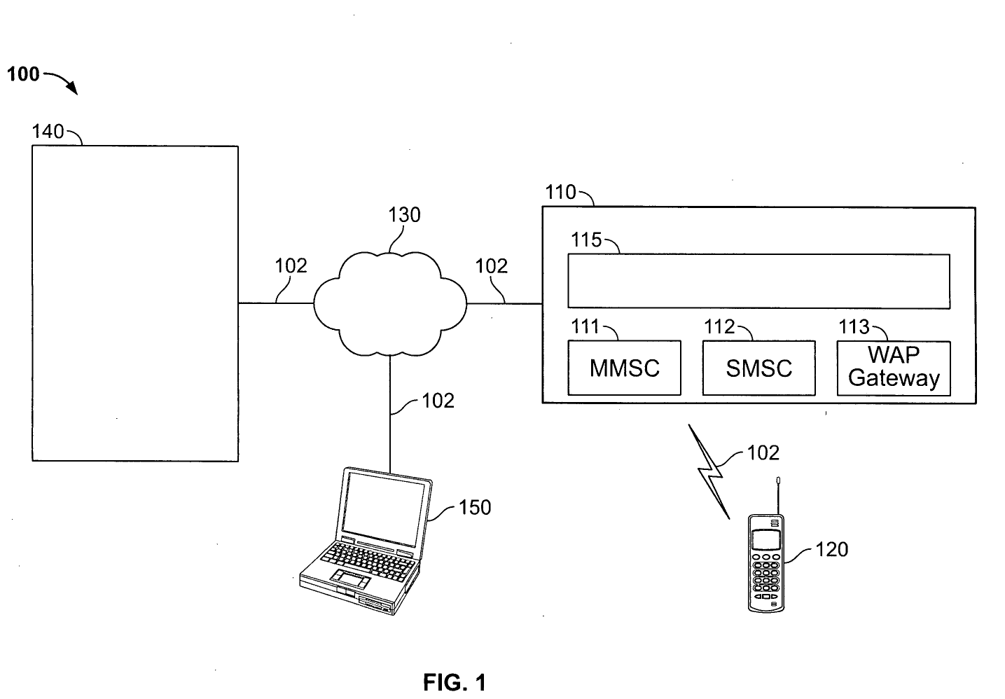

FIG. 1 illustrates a system in which the administration and control of a mobile digital content communication system is effected using a mobile device in accordance with one embodiment of the invention. System 100, shown in FIG. 1, includes a mobile service provider's operator network 110. A mobile device 120 is connected to the operator network 110. Operator network 110 has, in accordance with one embodiment of the invention, a control application 115 installed thereon that controls the mobile digital content communication system service for the mobile device 120. The operator network 110 also includes a multimedia message service (MMS) center (MMSC) 111, a short messaging service (SMS) center (SMSC) 112, and a WAP gateway 113 to communicate messages between the operator network 110 and the wireless device 120.

The mobile service provider's operator network 110 is connected via Internet 130 to any number of digital content storage devices, shown for example as digital processing system (DPS) 140. The DPS 140 may be a network server, personal computer, or other type of digital processing system. Such DPSs are configured to store and communicate a plurality of various types of digital content such as e-mails, news feeds, blogs, audio and video clips and multimedia, for example, as well as documents such as web pages, content stored on web pages, including text, graphics, and audio and video content. For example, the stored content may be audio/video files, such as programs with moving images and sound. The DPS 140 may store digital content for a user which may have been communicated from any of a variety of sources, shown for example, as DPS 150.

The stored digital content may be communicated through any type of communications network through which a plurality of different devices may communicate such as, for example, but not limited to, the Internet, a wide area network (WAN) not shown, a local area network (LAN), an intranet, or the like. For example, as shown in FIG. 1, the DPSs are interconnected one to another through Internet 130 which is a network of networks having a method of communicating that is well known to those skilled in the art.

Operator network 110 and the user's mobile device 120, which also have digital processing capability, as well as the DPSs 140 and 150 are coupled via communication links 102. The communication links 102 coupling the DPSs, the operator network, and the mobile device need not be direct links, but may be indirect links, including but not limited to, broadcasted wireless signals, network communications or the like.

The user may wish to have the digital content stored on DPS 140 communicated to the user's mobile device 120 in variety of different ways under different circumstances. In accordance with one embodiment of the invention, the user modifies operational aspects of a mobile digital content communication system service by providing a message to the application 115. The application determines the particular service based upon the origin of the message (e.g., the mobile device 120) and parses the message to determine the modification requested. For one embodiment of the invention, the message received from the user may be a short text message such as an MMS message or an SMS message.

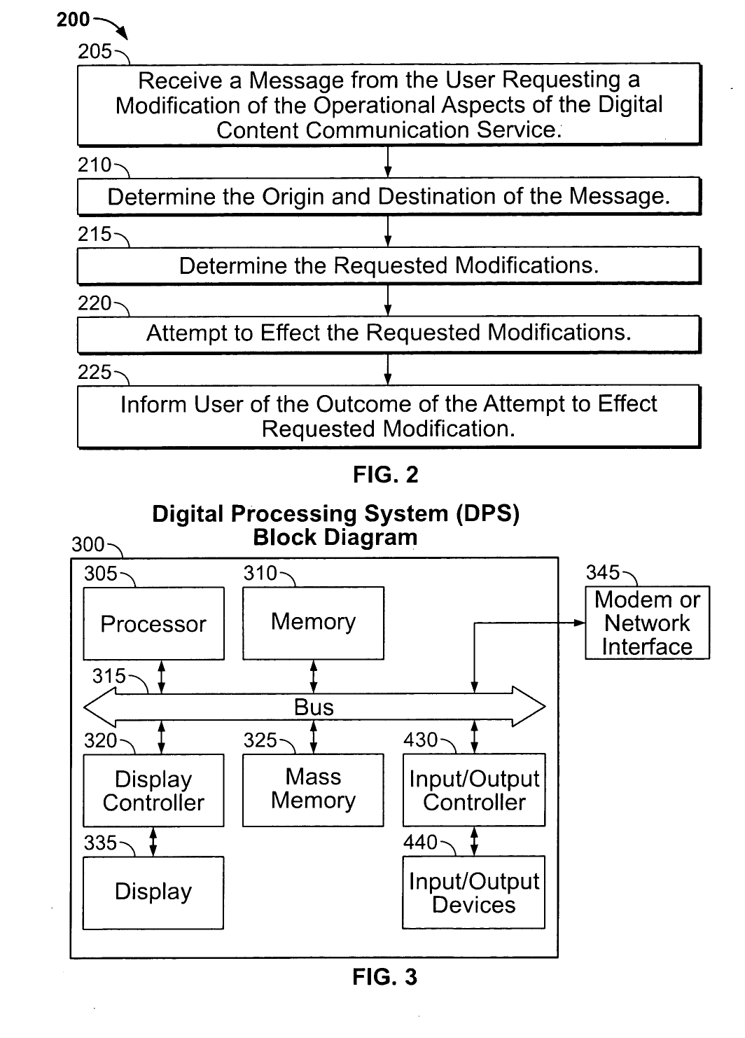

FIG. 2 illustrates a process in which changes to the operational aspects of a digital content communication system service are effected in accordance with one embodiment of the present invention. Process 200, shown in FIG. 2, begins with operation 205 in which the service provider receives a message from the user requesting a modification of the operational aspects of the digital content communication service. For one embodiment of the invention a syntax for the message is provided that allows for a quick and definite recognition of the change in operational aspects to be effected.

At operation 210 the service provider determines the origin and destination of the message. That is, the service provider determines the particular user's service from which the message originated and determines that the message is directed to the service provider. For example, for one embodiment of the invention the message is sent to a short code from a mobile device. The service provider is able to determine the service and user account associated with the originating device. The short code is recognized by a control application as being a message to the service provider (i.e., as opposed to a message between users). Messages so recognized then, are redirected by the service provider to the control application.

At operation 215 the requested modifications are determined from the message. For example, once the short code is recognized as a message to the service provider, the content of the message is analyzed to determine the request of the user (i.e., which modifications to the operational aspects of the identified digital content communication service the user requests).

At operation 220 the service provider attempts to effect the requested modification. For one embodiment of the invention the message is parsed to determine which operational aspects to modify and how to modify those aspects. For example, an embodiment may provide a syntax for request messages which is recognized and effected by the control application.

In general, the request message may be any message that requests a modification to the operational aspect of the digital content communication service. For example, the message may be a request to stop service or resume service. Such modification to the operational aspect of the digital content communication service can generally be effected quickly and efficiently (e.g., without further input from the user).

Other requests for modification to the operational aspect of the digital content communication service may be of a more sophisticated nature. For example, the request message may be to start forwarding messages from a particular e-mail account to the mobile device of the user. Methods for configuring digital content communication systems to communicate digital content with limited configuration information from the user are discussed in co pending application entitled “Configuration of Digital Content Communication Systems”. In some cases the information provided by the user may be insufficient to effect the requested modification to the operational aspects of the digital content communication service.

Moreover, the message from the user may not be understood and require further clarification from the user. In such case the user may be prompted to provide further or clarifying information.

At operation 225 the user is informed of the outcome of the attempt to effect the requested modification to the operational aspects of the digital content communication system service. That is, if the requested modification has been effected, the user is informed of this. In some cases, as noted above, it may not be possible to effect the requested modification, without further information from the user, if at all, in such case, the user is so informed.

As discussed above, for one embodiment of the invention a syntax is provided for messages requesting modification to the operational aspects of the digital content communication system service. For example, the commands “stop” and “start” by themselves may be used, respectively, to suspend and resume service. As another example, the commands “stop” and “start” having a specific source of digital content (e.g., an e-mail address) appended may be used to suspend or resume forwarding of the identified digital content. That is, for example, the command “stop” may be used to suspend service entirely, while “stop username@domainname.com” may suspend the communication of digital content from the identified source. Or for example, the command “deliver” followed by a time may be used to have digital content communicated to the user during a specified time. The syntax used can be varied to indicate any number of operational aspects of the digital content communication system.

Such syntax allows a relatively short message to adequately convey the user's request for modification. Moreover, the syntax allows the control application to quickly identify requests for modification to the operational aspects of the digital content communication system service and to determine the nature of the request.

The use of such syntax facilitates the transmission of the user's requests as short text messages such as SMS messages or MMS messages. Such short text messaging, typically used for communications between mobile devices may have limits on the message size and content. For example, SMS messages may be limited to 160 characters. The request syntax allows the request to be communicated as a MMS or SMS message. Moreover, because the user can quickly create and send a request the user is encouraged to make desired modifications to the operational aspects of the digital content communication system as desired.

As discussed above, embodiments of the invention are applicable to a variety of types of digital content. For example, embodiments of the invention are applicable to published digital content such as web-syndicated content that is made generally available to specific groups or the general public. Such published content is typically stored in a general repository where it is located and accessed by a number of users. In accordance with one embodiment of the invention, a user may provide a command (e.g., deliver) in conjunction with a generally used, or generally available name for such content to effect modification to operational aspects of the digital content communication system in regard to such content.

As discussed above, embodiments of the invention may employ DPSs or devices having digital processing capabilities. FIG. 3 illustrates a functional block diagram of a digital processing system that may be used in accordance with one embodiment of the invention. The components of processing system 300, shown in FIG. 3 are exemplary in which one or more components may be omitted or added. For example, one or more memory devices may be utilized for processing system 300. Referring to FIG. 3, the processing system 300, shown in FIG. 3, may be used as a server processing system. Furthermore, the processing system 300 may be used to perform one or more functions of an Internet service provider. The processing system 300 may be interfaced to external systems through a network interface or modem 345. The network interface or modem may be considered a part of the processing system 300. The network interface or modem may be an analog modem, an ISDN modem, a cable modem, a token ring interface, a satellite transmission interface, a wireless interface, or other interface(s) for providing a data communication link between two or more processing systems. The processing system 300 includes a processor 305, which may represent one or more processors and may include one or more conventional types of processors, such as Motorola PowerPC processor or Intel Pentium processor, etc. A memory 310 is coupled to the processor 305 by a bus 315. The memory 310 may be a dynamic random access memory (DRAM) an/or may include static RAM (SRAM). The processor 305 may also be coupled to other types of storage areas/memories (e.g. cache, Flash memory, disk, etc.), that could be considered as part of the memory 310 or separate from the memory 310.

The bus 315 further couples the processor 305 to a display controller 320, a mass memory 325 (e.g. a hard disk or other storage which stores all or part of the application 115, or stored digital content, depending on the DPS). The network interface or modem 345, and an input/output (I/O) controller 330. The mass memory 325 may represent a magnetic, optical, magneto-optical, tape, and/or other type of machine-readable medium/device for storing information. For example, the mass memory 325 may represent a hard disk, a read-only or writeable optical CD, etc. The display controller 320 controls, in a conventional manner, a display 335, which may represent a cathode ray tube (CRT) display, a liquid crystal display (LCD), a plasma display, or other type of display device. The I/O controller 330 controls I/O device(s) 340, which may include one or more keyboards, mouse/track ball or other pointing devices, magnetic and/or optical disk drives, printers, scanners, digital cameras, microphones, etc.

The processing system 300 represents only one example of a system, which may have many different configurations and architectures and which may be employed with the present invention. For example, various manufacturers provide systems having multiple busses, such as a peripheral bus, a dedicated cache bus, etc. On the other hand, a network computer, which may be used as a processing system of the present invention, may not include, for example, a hard disk or other mass storage device, but may receive routines and/or data from a network connection, such as the network interface or modem 345, to be processed by the processor 305. Similarly, a portable communication and data processing system, which may employ a cellular telephone and/or paging capabilities, may be considered a processing system that may be used with the present invention. However, such a system may not include one or more I/O devices, such as those described above with reference to I/O device 340.

In the system 300 shown in FIG. 3, the mass memory 325 (and/or the memory 310) may store data that may be processed according to the present invention. For example, the mass memory 325 may contain a database storing previously determined configuration information in accordance with one embodiment of the invention. Alternatively, data may be received by the processing system 300, for example, via the network interface or modem 345, and stored and/or presented by the display 335 and/or the I/O device(s) 340. In one embodiment, data may be transmitted across a data communication network, such as a LAN and/or the Internet.

General Matters

Embodiments of the invention include a system that receives messages specifying modification of the operational aspects of a digital content communication service at the operator network. The message is recognized as a request to modify the operational aspects of the service. The message is parsed to determine the modification to the operational aspects of the mobile messaging service, and the requested modifications are effected. For one embodiment of the invention, a request to modify the operational aspects of a mobile messaging service is sent as a short text message from a mobile device.

Embodiments of the invention have been described as including various operations. Many of the processes are described in their most basic form, but operations can be added to or deleted from any of the processes without departing from the scope of the invention.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a request message to modify an operational aspect of a digital content communication service from a user;
identifying the digital content communication service based upon an origination of the request message; and
modifying the operational aspect of the digital content communication service in accordance with the request message.

2. The method of claim 1 wherein the request message is received from a mobile device.

3. The method of claim 2 wherein the request message is a short text message.

4. The method of claim 3 wherein the short text message is selected form the group consisting of an MMS message, an SMS message, and an e-mail message.

5. The method of claim 4 wherein the request message is sent to a short code from the mobile device further comprising:
identifying the request message based upon a destination of the request message.

6. The method of claim 1 wherein the digital content communication service has operational aspects including suspending service, resuming service, forwarding stored digital content from a particular location, and suspending forwarding stored digital content from a particular location.

7. The method of claim 1, wherein the stored digital content is digital content selected from the group consisting of e-mail messages, news feeds, blogs, audio content, video content, and combinations thereof.

8. The method of claim 1 wherein the request message has a specific syntax, the syntax used to identify the requested modification of the operational aspect of the digital content communication service.

9. The method of claim 1 wherein the operational aspect is forwarding stored digital content from a particular location, further comprising:
prompting the user to provide additional information regarding the particular location upon having failed to locate and access the stored digital content.

10. A machine-readable medium that provides executable instructions, which when executed by a processor, cause the processor to perform a method, the method comprising:
receiving a request message to modify an operational aspect of a digital content communication service from a user;
identifying the digital content communication service based upon an origination of the request message; and
modifying the operational aspect of the digital content communication service in accordance with the request message.

11. The machine-readable medium of claim 10 wherein the request message is received from a mobile device.

12. The machine-readable medium of claim 11 wherein the request message is a short text message.

13. The machine-readable medium of claim 12 wherein the short text message is selected form the group consisting of an MMS message, an SMS message, and an e-mail message.

14. The machine-readable medium of claim 13 wherein the request message is sent to a short code from the mobile device wherein the method further comprises:
identifying the request message based upon a destination of the request message.

15. The machine-readable medium of claim 10 wherein the digital content communication service has operational aspects including suspending service, resuming service, forwarding stored digital content from a particular location, and suspending forwarding stored digital content from a particular location.

16. The machine-readable medium of claim 10 wherein the stored digital content is digital content selected from the group consisting of e-mail messages, news feeds, blogs, audio content, video content, and combinations thereof.

17. The machine-readable medium of claim 10 wherein the request message has a specific syntax, the syntax used to identify the requested modification of the operational aspect of the digital content communication service.

18. The machine-readable medium of claim 10 wherein the operational aspect is forwarding stored digital content from a particular location, wherein the method further comprises:
prompting the user to provide additional information regarding the particular location upon having failed to locate and access the stored digital content.

19. A system comprising:
one or more digital content storage devices storing digital content;
one or more communication devices capable of receiving and presenting digital content; and
a digital content communication device coupling at least one of the digital content storage devices to at least one of the communication devices;
a control application, stored on the digital content communication device, to receive a request message from a user, the request message requesting modification to an operational aspect of a digital content communication service, identify the digital content communication service based upon an origination of the request message, and modify the operational aspect of the digital content communication service in accordance with the request message.

20. The system of claim 19 wherein the request message from the user is received from a mobile communications device.

21. The system of claim 20 wherein the request message is a short text message.

22. The system of claim 21 wherein the short text message is selected form the group consisting of an MMS message, an SMS message, and an e-mail message.

23. The system of claim 22 wherein the request message is sent to a short code from the mobile device the application further identifying the request message based upon a destination of the request message.

24. The system of claim 19 wherein the digital content communication service has operational aspects including suspending service, resuming service, forwarding stored digital content from a particular location, and suspending forwarding stored digital content from a particular location.

25. The system of claim 19 wherein the stored digital content is digital content selected from the group consisting of e-mail messages, news feeds, blogs, audio content, video content, and combinations thereof.

26. The system of claim 19 wherein the request message has a specific syntax, the syntax used to identify the requested modification of the operational aspect of the digital content communication service.

27. The system of claim 19 wherein the operational aspect is forwarding stored digital content from a particular location, the application further prompting the user to provide additional information regarding the particular location upon having failed to locate and access the stored digital content.
